(19) United States
(12) Patent Application Publication
(10) Pub. No.: US 2021/0316571 A1
(43) Pub. Date: Oct. 14, 2021

(54) TIRE COMPRISING REINFORCING ELEMENTS IN THE FORM OF LAMINATED STRIPS

(71) Applicant: COMPAGNIE GENERALE DES ETABLISSEMENTS MICHELIN, Clermont-Ferrand (FR)

(72) Inventor: GAEL PATAUT, Clermont-Ferrand (FR)

(21) Appl. No.: 17/287,593

(22) PCT Filed: Oct. 17, 2019
(86) PCT No.: PCT/FR2019/052465

§ 371 Date: Apr. 22, 2021

(30) Foreign Application Priority Data
Oct. 22, 2018 (FR) 1859731

(51) Int. Cl. B60C 9/00; B60C 9/18; B60C 9/20; B60C 9/22

(52) U.S. Cl. CPC B60C 9/0028; B60C 9/0042; B60C 9/1821; B60C 9/2009; B60C 2009/2214; B60C 2009/2019; B60C 2009/2035; B60C 2009/2064; B60C 2009/208; B60C 9/2204

(57) ABSTRACT

The tire comprises a crown reinforcing zone comprising a ply of strips, each forming an angle of less than or equal to 10° with the circumferential direction. Each reinforcing strip is formed by a laminate made up of n inner composite layers comprising low-modulus oriented fibres parallel to each other, the angle of which with the circumferential direction is, in absolute terms, less than or equal to 10°, together with m outer composite layers on either side of the inner composite layers, comprising high-modulus oriented fibres parallel to each other, the angle of which with the circumferential direction is, in absolute terms, strictly greater than 10°. The high- and low-modulus fibres are coated with a polymer matrix.

The present invention relates to tyre reinforcing elements. It relates more particularly to tyre crown architectural elements.

Radial-carcass tyres, commonly referred to as “radial tyres”, have gradually become established in the majority of markets, and in particular the market for passenger vehicle tyres. This success is due in particular to the qualities of endurance, comfort, lightness of weight and low rolling resistance that radial tyres have to offer.

Radial tyres are essentially made up of flexible sidewalls and a stiffer crown, the sidewalls extending radially from the beads to the shoulders delimiting the crown, the crown supporting the tread of the tyre. Since each of these parts of the tyre has its own functions, the reinforcement thereof is also specific. One characteristic of radial tyre technology is that it makes it possible to precisely adapt the reinforcement of each of these parts in a relatively independent manner.

A passenger-vehicle radial tyre comprises, as is known, a radial carcass reinforcement made up of reinforcers (generally textile) connecting the two beads of the tyre, and a crown reinforcement comprising:
two crossed crown triangulation layers (or plies) that consist essentially of (generally metal) reinforcers that each make an angle of about 30 degrees with the circumferential direction of the tyre;
a crown belt that consists essentially of reinforcers virtually parallel to the circumferential direction of the tyre, often referred to as 0 degree reinforcers even though they generally form a non-zero angle with the circumferential direction, for example an angle ranging from 0 to 10 degrees.

Put simply, the carcass has the primary function of containing the internal pressure of the tyre, the crossed plies have the primary function of giving the tyre its cornering stiffness, and the crown belt has the primary function of withstanding crown centrifugation at high speed. Moreover, the cooperation of all of these reinforcement elements creates what is known as the “crown triangulation”. It is this triangulation which gives the tyre its capacity to maintain a relatively cylindrical shape under the various stresses.

Each of these crown reinforcement elements is generally associated, by skimming, with elastomeric compounds. The stack of these elements is then joined together during the vulcanization of the tyre.

After several decades of research, progress and optimization of the radial tyre architecture, it is the combination of all of these reinforcement elements (carcass, crossed layers, belt) that allows the radial tyre to achieve the undeniable comfort, longevity and cost performance that has made it the success it is. Throughout this development, attempts have been made to improve the performance of the tyres, for example in terms of their mass and their rolling resistance. Thus the crown of radial tyres has gradually been reduced in thickness as increasingly high-performance reinforcers have been adopted and increasingly thinner layers of skim rubber have been used so that the lightest possible tyres having a lower rolling resistance can be manufactured.

Document WO2010115860 describes a passenger vehicle tyre in which the crown reinforcement is made up of three distinct and separate elements: a radial carcass reinforcement made of reinforcers that connect the two beads of the tyre, a crown belt essentially made up of reinforcing elements parallel to the circumferential direction of the tyre, and a triangulation crown layer essentially made up of reinforcing elements that make an angle with the circumference of the tyre. Such an architecture has numerous advantages from the point of view of the performance of the tyre, but involves a complicated manufacturing method with numerous steps. Finally, the number of sub-layers that are present limits the potential savings in terms of mass.

Document EP 0101400 describes a radial tyre having a plurality of semi-rigid annular bands disposed in a crown portion of the tyre. The bands are arranged substantially across the entire width of the tread of the tyre. According to one particular embodiment, the tread comprises a reinforcing structure having a central band and two side bands. The bands, which are relatively wide and independent of one another, each comprise fibrous reinforcers incorporated in an epoxy resin matrix, forming a semi-rigid hoops structure. This then is found to be highly complex to produce.

In order to alleviate these various disadvantages, notably the complexity of production, document WO2017/013575 describes a tyre for a passenger vehicle comprising a crown reinforcing zone comprising two radially superposed layers, each layer being made up of composite strips coated with an elastomer compound and arranged juxtaposed with one another and at an angle of around 0° with respect to the circumferential direction, and which can incorporate a thermoplastic film.

However, there is still a need to optimize the performance still further in terms of extension stiffness and shear stiffness and to reduce the noise emissions of a tyre, while at the same time minimizing the mass of the crown reinforcing zone of the tyres.

In the course of research, the applicant has discovered that a new architecture of the reinforcing zone of the tyre makes it possible, while still overcoming the known drawbacks of conventional architectures, to improve the performance in extension and shear of this reinforcing zone, and while reducing the noise generated by the tyre, by facilitating the manufacturing method of the tyre as far as possible and by maintaining or even improving the hooping function of the tyre.

To this end, the object of the invention is a tyre comprising a carcass ply connecting two beads via two sidewalls, said carcass ply being surmounted radially towards the outside of the tyre by a crown reinforcing zone which is itself surmounted radially towards the outside of the tyre by a tread, the crown reinforcing zone comprising a plurality of reinforcing strips arranged in at least one ply of strips, said strips being arranged so that they are juxtaposed axially and each is at an angle of less than or equal to 10° with respect to the circumferential direction, characterized in that each reinforcing strip is made up of a laminate consisting of:
n≥1 inner composite layer or layers, these inner composite layers being juxtaposed radially with each other if n>1, each inner composite layer comprising fibres oriented parallel to each other, whose angle to the circumferential direction is less than or equal to 10° in absolute terms, the oriented fibres of each inner composite layer having a modulus of extension of less than or equal to 30 GPa and being coated with a polymer matrix, the inner composite layer or layers being framed radially on either side, respectively, by m≥1 outer composite layers, and, if m>1, these m outer composite layers being juxtaposed radially with each other on each side of the inner composite layer or layers,
each outer composite layer comprising fibres oriented parallel to each other, the angle of which to the circumferential direction is strictly greater than 10° in absolute terms, the oriented fibres of each outer composite layer having a modulus of extension of more than or equal to 55 GPa and being embedded in a polymer matrix.

What is meant by a tyre is a casing which, once mounted on a mounting support, for example a wheel rim, delimits a closed cavity, it being possible for this cavity to be pressurized with a gas.

In the present application, unless expressly indicated otherwise, any range of values denoted by the expression “between a and b” represents the range of values from more than “a” to less than “b” (i.e. limits a and b excluded), while any range of values denoted by the expression “from a to b” means the range of values from “a” up to “b” (i.e. including the strict limits a and b).

The positive or negative sign of an angle is defined by its orientation, namely the direction, clockwise or anticlockwise, in which it is necessary to rotate from a reference straight line, in this instance the circumferential direction of the tyre, defining the angle in order to reach the other straight line defining the angle. For example, it may be adopted by convention that an angle oriented in the anticlockwise direction from the reference straight line, in this instance the circumferential direction, has a positive sign and that an angle oriented in the clockwise direction from the reference straight line, in this instance the circumferential direction, has a negative sign. Equally, the reverse convention could be adopted.

The carcass ply of the tyre according to the invention preferably comprises filamentary carcass reinforcing elements that extend axially from one to the other bead of the tyre, passing through each sidewall and under the crown of the tyre. Preferably, each filamentary carcass reinforcing element extends in a direction that makes an angle greater than or equal to 65°, preferably greater than or equal to 80°, and even more preferably substantially equal to 90°, with the circumferential direction of the tyre.

According to the invention, each strip forms an angle of less than or equal to 10° with the circumferential direction of the tyre. Specifically, each strip, on account of its shape, extends in a main direction along its longest length, and this main direction of the strip forms an angle of less than or equal to 10° with the circumferential direction of the tyre.

According to the invention, the inner composite layer or layers can provide a hooping function for the tyre, by taking up the longitudinal forces and therefore obviating the use of a conventional hooping ply comprising filamentary reinforcing elements arranged substantially parallel to each other and forming an angle of less than or equal to 10° with the circumferential direction of the tyre and embedded in a matrix of rubber compound. Above all, in order to allow easy radial and circumferential deformation of the tyre during its manufacturing process, the oriented fibres of this inner composite layer or layers have a relatively low modulus, allowing easy deformation under a low stress of the crown reinforcing zone during the tyre manufacturing process, even if the angle of the oriented fibres of the inner composite layer or layers is relatively small.

According to the invention, the outer composite layers make it possible to improve the extension and shear performance of the crown reinforcing zone, as a result of the use of high-modulus oriented fibres and the angle of these high-modulus oriented fibres.

Finally, again according to the invention, the inventors of the present invention propose the a posteriori hypothesis that the noise generated by the tyre depends essentially on the transverse and longitudinal Poisson ratios of each laminate, and that the noise generated by the tyre decreases as these Poisson ratios increase. Thus the inventors have discovered that when low-modulus oriented fibres were placed at a relatively small angle, less than or equal to 10° in this case, the Poisson ratios of each laminate were, everything else being equal, relatively high.

In a first embodiment, the oriented fibres consist of mutually parallel individual spun fibres known as “rovings”. In this embodiment, each composite layer is made up of the oriented fibres coated in the polymer matrix.

In a second embodiment, the oriented fibres consist of filamentary elements of a fabric comprising substantially mutually parallel first filamentary elements and substantially mutually parallel second filamentary elements interlacing with the first filamentary elements, the oriented fibres being either the first filamentary elements or the second filamentary elements.

This second embodiment thus makes it possible to create a single composite layer comprising first and second oriented fibres belonging to the one same fabric wherever the first embodiment would have required two composite layers each comprising oriented fibres.

In one preferred embodiment, with the tyre comprising a crown surmounting the carcass ply, radially towards the outside of the tyre, and comprising the tread and the crown reinforcing zone, the crown is, with the exception of the crown reinforcing zone, devoid of any ply reinforced by filamentary reinforcing elements arranged substantially parallel to one another and embedded in a matrix of rubber compound. The filamentary reinforcing elements of such reinforced plies excluded from the crown of the tyre comprise the metal filamentary reinforcing elements and the textile filamentary reinforcing elements.

In one highly preferred embodiment, with the tyre comprising a crown surmounting the carcass ply, radially towards the outside of the tyre, the crown is made up of the crown reinforcing zone and the tread.

In one even more preferred embodiment, the crown reinforcing zone is, with the exception of the ply or plies of strips embedded in the matrix of rubber compound, devoid of any ply that is reinforced by filamentary reinforcing elements arranged substantially parallel to one another and embedded in a matrix of rubber compound. The filamentary reinforcing elements of such reinforced plies excluded from the crown reinforcing zone comprise the metal filamentary reinforcing elements and the textile filamentary reinforcing elements.

In the most preferred embodiment, the crown reinforcing zone is made up of the ply or plies of strips embedded in the matrix of rubber compound.

Furthermore, highly advantageously, the tyre is, radially between the carcass ply and the crown, devoid of any ply that is reinforced by filamentary reinforcing elements arranged substantially parallel to one another and embedded in a matrix of rubber compound. The filamentary reinforcing elements of such reinforced plies excluded from in between the carcass ply and the crown comprise the metal filamentary reinforcing elements and the textile filamentary reinforcing elements.

In one preferred embodiment that makes it possible to improve the mechanical properties of the tyre, the tyre comprises at least two plies of strips, a first ply of strips radially on the inside and a second ply of strips radially on the outside, said strips of each first and second ply of strips being arranged so that they are juxtaposed axially, each forming an angle of less than or equal to 10° with the circumferential direction.

Also in an embodiment enabling the mechanical properties of the tyre to be improved, the mean overlap between the strips of the first and second plies of strips is greater than or equal to 20%, preferably 40%. The mean overlap between the first and second plies of strips is the mean of the individual overlaps of the strips of the first ply by the strips of the second ply. The individual overlap between a strip of the first ply and one or more strips of the second ply is the percentage ratio
of the axial width of the radial projection of the strip of the first ply on the strip or strips of the second ply,
to
the axial width of the strip of the first ply.

The percentage of overlap may vary according to embodiments. This overlap forms a coupling between the plies of strips, creating cohesion of the entirety of the crown reinforcing zone. This coupling allows, in particular, the transmission of shear forces between the plies of strips. The presence of the rubber compound matrix is not taken into consideration in the value of this mean overlap.

According to another preferred variant embodiment of the invention, the mean overlap between the strips of the first and second plies of strips is less than or equal to 80%, preferably less than or equal to 60%. This ensures the presence of a rubber bridge having an axial width that provides decoupling between two axially juxtaposed strips.

In a variant in which the tyre comprises at least three plies of strips, the mean overlap between the strips of each ply of strips overlapping the strips of the ply of strips radially on the inside thereof is greater than or equal to 20%, preferably greater than or equal to 40%, and less than or equal to 80%, preferably less than or equal to 60%.

Preferably, each strip of each ply of strips forms an angle of less than or equal to 5° with the circumferential direction, and very preferably substantially zero with the circumferential direction.

Highly advantageously, each ply of strips is embedded in a matrix of rubber compound which, when cross-linked, has a secant extension modulus at 10% elongation greater than or equal to 10 MPa. In one embodiment in which the aim is to maximize the noise reduction, the secant extension modulus at 10% of elongation is preferably less than or equal to 30 MPa and more preferably less than or equal to 20 MPa.

The measurements are taken in second elongation (i.e. after a cycle of accommodation at the degree of extension intended for the measurement itself). These tensile tests make it possible to determine the elasticity stresses and the properties at break. They are performed in accordance with the French standard NF T 46-002 of September 1988. The nominal secant extension moduli (or apparent stresses, in MPa) are measured in second elongation (i.e. after an accommodation cycle at the degree of extension intended for the measurement itself) at 10% elongation (denoted MA 10) at 23° C.±2° C., and under normal hygrometry conditions.

The expression compound “based on” should be understood as meaning a compound comprising the mixture and/or the reaction product of the various constituents used, some of these base constituents being capable of reacting, or intended to react, with one another, at least in part, during the various phases of manufacture of the compound, in particular during its crosslinking or vulcanization.

It should be noted that the compounds mentioned below and participating in the preparation of rubber compounds can be of fossil or biosourced origin. In the latter case, they can result, partially or completely, from biomass or be obtained from renewable starting materials resulting from biomass. Polymers, plasticizers, fillers and the like are concerned in particular.

The rubber compound matrix is based on at least one diene or non-diene (for example thermoplastic) elastomer; this is preferably a compound of the crosslinked or cross-linkable type, which is to say that it then comprises a crosslinking system (notably a vulcanizing system) suitable for allowing the compound to crosslink (harden) as it is being cured (or as the rubber item such as the tyre incorporating a crown zone according to the invention is being cured).

Preferably, the elastomer is a diene elastomer. As is known, diene elastomers can be classified into two categories: “essentially unsaturated” or “essentially saturated”. The term “essentially unsaturated” is understood to mean a diene elastomer resulting at least in part from conjugated diene monomers having a content of units of diene origin (conjugated dienes) which is greater than 15% (mol %); thus it is that diene elastomers such as butyl rubbers or copolymers of dienes and of alpha-olefins of EPDM type do not come under the above definition and can especially be described as “essentially saturated” diene elastomers (low or very low content of units of diene origin, always less than 15%). In the category of “essentially unsaturated” diene elastomers, a “highly unsaturated” diene elastomer in particular refers to a diene elastomer having a content of units of diene origin (conjugated dienes) which is greater than 50%. Although it is applicable to any type of diene elastomer, the present invention is preferably carried out with a diene elastomer of the highly unsaturated type.

This diene elastomer is more preferably selected from the group consisting of polybutadienes (BRs), natural rubber (NR), synthetic polyisoprenes (IRs), butadiene copolymers, isoprene copolymers and mixtures of these elastomers, such copolymers being notably selected from the group consisting of butadiene/styrene copolymers (SBRs), isoprene/butadiene copolymers (BIRs), isoprene/styrene copolymers (SIRs) and isoprene/butadiene/styrene copolymers (SBIRs).

The rubber compound may contain a single diene elastomer or several diene elastomers, the latter possibly being used in combination with any type of synthetic elastomer other than a diene elastomer, or even with polymers other than elastomers. The rubber compound can also comprise all or part of the additives known to those skilled in the art and normally used in rubber compounds intended for the manufacture of tyres, such as, for example, reinforcing fillers, such as carbon black or silica, coupling agents, non-reinforcing fillers, plasticizers (plasticizing oils and/or plasticizing resins), pigments, protective agents, such as antiozone waxes, chemical antiozonants, antioxidants, anti-fatigue agents or reinforcing resins (such as described, for example, in application WO 02/10269), a crosslinking system, for example based on sulphur and other vulcanizing agents and/or on peroxide and/or on bismaleimide.

A person skilled in the art will know, in the light of the present description, how to adjust the formulation of the rubber compound in order to achieve the desired levels of properties (in particular modulus MA10) and to adapt the formulation to the specific application envisaged.

It is well known to increase the stiffness of rubber compounds by increasing for example their content of reinforcing filler, the content of sulphur and other vulcanizing agents, or else by introducing reinforcing resins, it being possible for all of these solutions to be combined in order to obtain higher stiffnesses.

Very preferably, the angle formed by the oriented fibres of each inner composite layer with the circumferential direction is, in terms of absolute value, less than or equal to 5°, and preferably substantially zero.

Very preferably, the angle formed by the oriented fibres of each outer composite layer with the circumferential direction ranges from 30° to 60° in terms of absolute value. Excessively small angles, that is to say those of less than 30° in terms of absolute value, impart a relatively high longitudinal stiffness to each laminate and therefore a relatively low longitudinal Poisson ratio, thereby adversely affecting the reduction of the noise generated by the tyre. Similarly, excessively large angles, that is to say those of more than 60° in terms of absolute value, impart a relatively high transverse stiffness to each laminate and therefore a relatively low transverse Poisson ratio, thereby adversely affecting the noise reduction provided by the tyre.

Advantageously, n ranges from 1 to 20, preferably from 1 to 12, and more preferably from 1 to 6. Advantageously, m ranges from 1 to 8, or preferably from 1 to 4, and more preferably m=1 or 2. Such values of n and m make it possible to provide high mechanical strength properties, while also lightening the crown reinforcing zone compared with a conventional tyre.

In one embodiment for producing a laminate having a balanced structure, the sum of the angles formed with the circumferential direction by the oriented fibres of all the outer composite layers arranged radially on any one side of the inner composite layer or layers of each laminate is equal, in absolute terms, to the sum of the angles formed with the circumferential direction by the oriented fibres of all the outer composite layers arranged radially on the other side of the mid-plane of said laminate. The mid-plane of the laminate is the plane parallel to the main direction of the laminate, located equidistantly from the radially inner and outer faces of the laminate. Preferably, the sum of the angles formed with the circumferential direction by the oriented fibres of all the outer composite layers arranged radially on any one side of the inner composite layer or layers of each laminate is equal in value to the sum of the angles formed with the circumferential direction by the oriented fibres of all the outer composite layers arranged radially on the other side of the mid-plane of said laminate. In this variant, the risk of warping of the laminate is minimized.

In one even more preferred embodiment that creates no orientation of the reinforcement in the tyre, the sum of the angles formed with the circumferential direction by the oriented fibres of the outer composite layers of each laminate is equal to 0°.

In one embodiment, the angle of the oriented fibres of two outer composite layers arranged symmetrically on each side of the inner composite layer or layers is identical. In such an embodiment, called symmetrical, each laminate can be used independently of its laying direction in the tyre.

In another embodiment, the angles of the oriented fibres of two outer composite layers arranged symmetrically on each side of the inner composite layer or layers are identical in absolute terms but of opposite sign.

Very advantageously, and in order to maximize the reduction of the noise generated by the tyre and the mechanical properties of each laminate, the absolute value of the ratio of each angle formed by the oriented fibres of one outer composite layer of each laminate to the angle formed by the oriented fibres of each other outer composite layer of said laminate ranges from 0.8 to 1.2, preferably from 0.9 to 1.1, and more preferably is equal to 1. This is because the presence of a composite layer in which the oriented fibres have a significantly different angle from the angles of the oriented fibres of the other composite layers may result in a reduction of noise gain, but may also reduce the mechanical properties of each laminate, due to the non-uniformity of this composite layer created in the laminate.

Advantageously, the polymer matrix of each composite layer of laminate comprises a thermosetting polymer or a thermoplastic polymer.

According to the invention, the oriented fibres of each outer composite layer comprise oriented fibres having a high modulus. What is meant in the present application by high modulus is a modulus of extension (Young's modulus) greater than or equal to 55 GPa. Such a modulus of extension is measured in accordance with the standard ASTM D4848-98 (2012).

Advantageously, the oriented fibres of each outer composite layer are chosen from among glass fibres, carbon fibres, aromatic polyamide or aromatic copolyamide fibres, basalt fibres, quartz fibres, and mixtures of these fibres.

In one embodiment, the oriented fibres of each outer composite layer of laminate comprise glass fibres, and, preferably, the fibres of each composite layer of laminate predominantly comprise glass fibres. In this embodiment, the polymer matrix/oriented fibres ratio by volume in each composite layer ranges from 30/70 to 80/20.

In another embodiment, the oriented fibres of each composite layer of laminate comprise carbon fibres, and, preferably, the fibres of each composite layer of laminate predominantly comprise carbon fibres. In this embodiment, the polymer matrix/oriented fibres ratio by volume in each outer composite layer ranges from 30/70 to 90/10.

According to the invention, the fibres of each inner composite layer comprise oriented fibres having a low modulus. What is meant in the present application by low modulus is a modulus of extension (Young's modulus) less than or equal to 30 GPa, preferably ranging from 6 GPa to 30 GPa. Such a modulus of extension is measured in accordance with the standard ASTM D4848-98 (2012).

Advantageously, the oriented fibres of each inner composite layer are chosen from among polyester fibres, cellulose fibres, aliphatic polyamide fibres, and mixtures of these fibres.

According to a preferred variant embodiment of the invention, the low-modulus oriented fibres of each inner composite layer comprise polyethylene terephthalate fibres. Preferably, the polyethylene terephthalate oriented fibres predominate, that is to say represent more than 50% of the oriented fibres of any one inner composite layer. More preferably still, the oriented fibres of each inner composite layer are made up of polyethylene terephthalate fibres.

According to other preferred variant embodiments of the invention, the oriented fibres of each inner composite layer comprise aliphatic polyamide fibres (such as semi-aromatic PA66, PA46, PA6, PA10), cellulose or rayon fibres, or low-modulus thermoplastic fibres. Each of these types of fibre can be used preferably as predominant content, namely representing more than 50% of the oriented fibres in any one inner composite layer, and more preferably still each of these types of oriented fibre constituting all of the oriented fibres in each inner composite layer.

Advantageously, the polymer matrix/oriented fibres ratio by volume in each inner composite layer ranges from 25/75 to 55/45.

The invention will be understood better on reading the following description, which is given purely by way of non-limiting example and with reference to the drawings, in which:

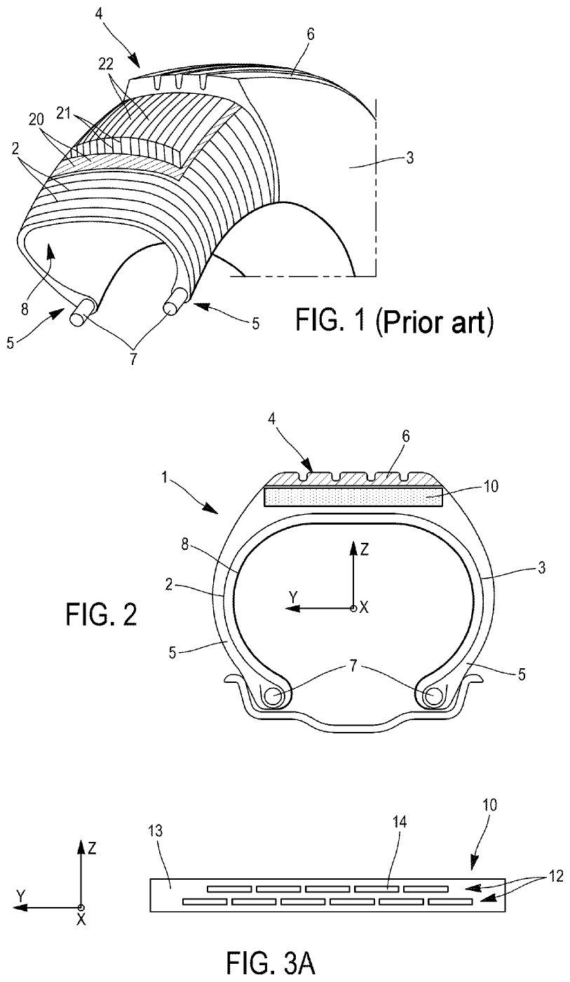

FIG. 1 is a schematic perspective depiction of a tyre according to the prior art;

FIG. 2 is a sectional view of a tyre according to the invention;

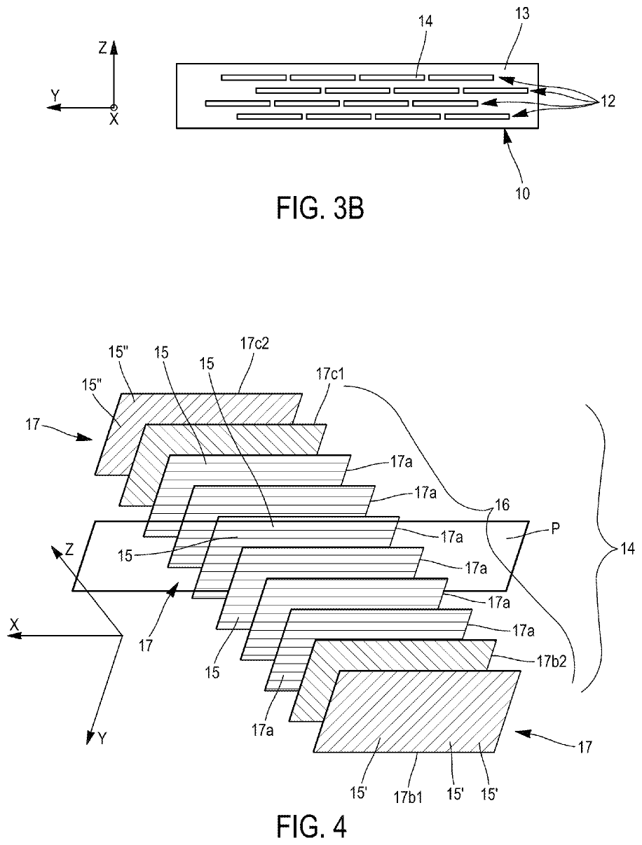

FIG. 3A is a schematic representation of a crown reinforcing zone of the tyre according to the invention as shown in FIG. 2;

FIG. 3B is a schematic representation of a reinforcing zone according to a second embodiment of the invention; and

FIG. 4 is an exploded view of a strip of the crown reinforcing zone of FIG. 3A.

A frame of reference X, Y, Z corresponding to the usual respectively axial (along the Y direction), radial (along the Z direction) and circumferential (along the X direction) orientations of a tyre has been represented in the figures.

A “longitudinal direction” or “circumferential direction” means a direction which corresponds to the periphery of the tyre and which is defined by the direction in which the tyre runs.

An “axial direction” means a direction parallel to the axis of rolling of the tyre.

The “tread” of a tyre means a quantity of elastomeric compound delimited by lateral surfaces and by two main surfaces, one of which is intended to come into contact with a road surface when the tyre is rolling.

The “sidewall” of a tyre means a lateral surface of the tyre, said surface being disposed between the tread of the tyre and a bead of this tyre.

The “bead” of a tyre means a part of the tyre that is intended to be seated on a wheel rim.

FIG. 1 illustrates a perspective view of a tyre, partially cut away layer by layer, for a conventional passenger vehicle according to the prior art. A carcass reinforcement 2 connected to the beads 5 around bead wires 7 extends along the sidewalls 3 and the crown 4. The carcass reinforcement 2 is formed of radially oriented reinforcers. The reinforcers are textile cords (for example made of nylon, rayon, polyester). At the crown of the tyre, the carcass is surmounted by two crossed triangulation layers 20, 21 and a belt 22. The two crossed crown triangulation layers 20, 21 comprise reinforcers oriented at an angle of substantially between 20 and 40 degrees on either side of the circumferential direction of the tyre. Metal cords constitute the reinforcers of the crossed layers 20, 21. A layer 8 of elastomeric sealing compound covers the internal cavity of the tyre. A tread 6 surmounts the whole. This architecture involves several semi-finished layers, requiring a manufacturing method with numerous intermediate steps. The numerous layers render the tyre relatively heavy.

FIG. 2 shows a tyre 1 according to the invention, comprising a carcass ply 2 connecting two beads 5 via two sidewalls 3. The carcass ply 2 is surmounted radially towards the outside of the tyre by a crown 4, which comprises a crown reinforcing zone 10 and is itself surmounted radially towards the outside of the tyre by a tread 6. Thus the crown reinforcing zone 10 is arranged radially between the tread 6 and the carcass ply 2. The carcass ply 2 extends from one bead 5 to the other, passing through the sidewalls 3 and the crown 4.

The crown 4 is, with the exception of the crown reinforcing zone 10, devoid of any ply reinforced by filamentary reinforcing elements arranged substantially parallel to one another and embedded in a matrix of rubber compound. The filamentary reinforcing elements of such reinforced plies excluded from the crown 4 of the tyre 1 comprise the metal filamentary reinforcing elements and the textile filamentary reinforcing elements. In this instance, the crown 4 is made up of the crown reinforcing zone 10 and the tread 6.

The tyre 1 is, radially between the carcass ply 2 and the crown 4, devoid of any ply that is reinforced by filamentary reinforcing elements arranged substantially parallel to one another and embedded in a matrix of rubber compound. The filamentary reinforcing elements of such reinforced plies excluded from in between the carcass ply 2 and the crown 4 comprise the metal filamentary reinforcing elements and the textile filamentary reinforcing elements.

The crown reinforcing zone 10 comprises a plurality of reinforcing strips 14 arranged in at least one ply 12 of strips. The strips 14 of each ply 12 of strips are arranged in an axially juxtaposed manner. In this instance, the crown reinforcing zone 10 comprises at least two plies of strips, a first ply of strips radially on the inside and a second ply of strips radially on the outside. Each strip 14 forms an angle of less than or equal to 10° with the circumferential direction Z, preferably an angle of less than or equal to 5° with the circumferential direction Z, and in this case, very preferably, substantially zero with the circumferential direction.

Each ply 12 of strips 14 is embedded in a matrix 13 of rubber compound which, in the cross-linked state, has a secant extension modulus at 10% elongation greater than or equal to 10 MPa, and preferably less than or equal to 30 MPa, and more preferably less than or equal to 20 MPa, and in this case equal to 12 MPa.

In this instance, the matrix 13 of rubber compound used here is a high-stiffness compound, typically of the type for tyre crown plies, based on natural rubber, carbon black (around 75 phr), antioxidant, a vulcanization system with a high sulphur content (around 7 phr), and the customary vulcanization additives. The adhesion between the strips 14 and the matrix 13 of rubber compound is provided by an adhesive of the RFL type which has been deposited, in a known manner, on the strips 14.

In the embodiment of FIG. 3A, the strips 14 of each ply of strips 14 are arranged with a lateral offset of each of the two plies 12 of strips 14 of around half a width of the strip. Such an arrangement has the effect of covering the bridges of rubber compound of the first ply with the strips that make up the second ply of strips. The bridges of rubber compound between the strips of the first ply of strips are thus positioned substantially at the middle of the respective widths of the strips of the adjacent ply of strips. In this example, the radially outer ply of strips has one less winding in order to compensate for the effect of the lateral offset. In a ply 12 of strips, the quincuncial positioning of the strips 14 is provided, for example, by a first winding-off starting at a given azimuth, and a second winding-off with an identical path starting at 180 degrees. In a variant, the strips 14 are positioned by first winding-off in one given axial direction, followed by second winding-off in the opposite axial direction.

Each strip 14 has an axial width of 15 mm and the rubber bridge separating two axially adjacent strips of any one ply of strips is equal to 1 mm in this case. The space in the radial (or thickness) direction between two successive plies of strips occupied by the matrix 13 of rubber compound is preferably between 0.05 and 2 mm, more preferably between 0.1 and 1 mm. For example, thicknesses of 0.2 to 0.8 mm have proved to be perfectly suitable for reinforcing a tyre. The thickness of the matrix 13 of rubber compound between the two plies of strips 12 is 0.2 mm in this case, this relatively small thickness allowing excellent coupling between the plies of strips, owing to the moderate value of the secant extension modulus at 10% of elongation MA10 of the matrix 13 of rubber compound.

The mean overlap between the strips 14 of the first and second plies 12 of strips is greater than or equal to 20%, preferably greater than 40% and less than or equal to 80%, preferably equal to 60%, and in this case equal to 46%.

The crown reinforcing zone 10 is, with the exception of the plies 12 of strips 14 embedded in the matrix 13 of rubber compound, devoid of any ply that is reinforced by filamentary reinforcing elements arranged substantially parallel to one another and embedded in a matrix of rubber compound. The filamentary reinforcing elements of such reinforced plies excluded from the crown reinforcing zone 10 of the tyre 1 comprise the metal filamentary reinforcing elements and the textile filamentary reinforcing elements. In this instance, the crown reinforcing zone 10 is made up of the plies 12 of strips 14 embedded in the matrix 13 of rubber compound.

Each reinforcing strip 14 of the plies of strips 14 is composed of a laminate 16 made up of at least 3 composite layers 17. In this instance, the laminate 17 is made up of n≥1 inner composite layer(s) 17a and m≥1 outer composite layers 17b, 17c, the inner composite layer or layers 17a being framed radially on either side, respectively, by one or more outer composite layers 17b and one or more outer composite layers 17c.

Advantageously, n ranges from 1 to 20, preferably from 1 to 12, and more preferably from 1 to 6, and in this case n=6. Advantageously, m ranges from 1 to 8, or preferably from 1 to 4, and more preferably m=1 or 2, and in this case m=2.

In this case, the n inner composite layers 17a are radially juxtaposed with each other, and the m outer composite layers 17b, 17c are, on either side of the inner composite layers 17a, radially juxtaposed with each other.

Each inner composite layer 17a comprises oriented fibres 15 parallel to each other, at an angle to the circumferential direction Z which is, in terms of absolute value, less than or equal to 10°, preferably less than or equal to 5°, and in this case substantially zero.

Each outer composite layer 17b, 17c comprises oriented fibres 15′, 15″ respectively, parallel to each other, at an angle to the circumferential direction Z which is, in terms of absolute value, strictly greater than 10°, preferably in the range from 30° to 60° and this case equal, in absolute terms, to 45°. In this embodiment, the angles of the oriented fibres 15′, 15″ of two outer composite layers 17b, 17c arranged symmetrically on each side of the inner composite layers 17a are identical. In another embodiment, not illustrated but exhibiting the same mechanical performance in respect of noise and ease of application in the tyre manufacturing process, the angles of the oriented fibres 15′, 15″ of two outer composite layers 17b, 17c arranged symmetrically on each side of the inner composite layers 17a are identical in absolute terms but of opposite sign.

In this case, the oriented fibres 15′ of the outer composite layer 17b1 radially on the inside are at an angle equal to +45°. The oriented fibres 15′ of the outer composite layer 17b2 radially on the outside and in contact with the inner composite layers 17a are at an angle equal to −45°. The oriented fibres 15″ of the outer composite layer 17c1 radially on the inside and in contact with the inner composite layers 17a are at an angle equal to −45°. The oriented fibres 15″ of the outer composite layer 17c2 radially on the outside are at an angle equal to +45°.

The absolute value of the ratio of each angle formed by the oriented fibres 15′, 15″ of each outer composite layer 17b, 17c of the laminate 16 to the angle formed by the oriented fibres 15′, 15″ of each other outer composite layer 17b, 17c of the laminate 16 ranges from 0.8 to 1.2, preferably from 0.9 to 1.1, and more preferably is equal to 1.

Additionally, the sum of the angles formed with the circumferential direction by the oriented fibres 15′, 15″ of the outer composite layers 17b and 17c of the laminate 16 is equal to 0°.

Furthermore, the sum of the angles formed with the circumferential direction Z by the oriented fibres 15′ of all the outer composite layers 17b arranged radially on any one side of the inner composite layers 17a of the laminate 16, 0 in this case, is equal in value, and also equal in absolute terms in this case, to the sum of the angles formed with the circumferential direction Z by the oriented fibres 15″ of all the outer composite layers 17c arranged radially on the other side of the mid-plane P of the laminate 16, which sum is also 0 in this case.

The oriented fibres 15 of each inner composite layer 17a are low-modulus and have a modulus of extension less than or equal to 30 GPa, whereas the oriented fibres 15′, 15″ of each outer composite layer 17b, 17c are high-modulus and have a modulus of extension greater than or equal to 55 GPa. The oriented fibres 15, 15′, 15″ are coated with a polymer matrix.

The composite strips 14 may be made from preimpregnated composite layers NTPT ThinPreg 450™ or NTPT ThinPreg 402™ (which can be obtained notably by applying the method described in document WO 2016/198171).

The preimpregnated composite layers are laid raw or unpolymerized at the desired lamination angles and form a width the dimension of which is greater than the width of the strips. The laminated sheet is cut into raw or unpolymerized strips of a desired width. The raw strips are wound off onto a drum of large diameter (i.e. 2 metres in diameter). The strips are cured under vacuum (−850 mbar) and under pressure (5 bar) using the usual curing peripherals (such as peel ply, bleeder cloth, microperforated or non-perforated release film, vacuum-bagging film, etc.). According to another embodiment, the laminated width is laid on a large-diameter drum and cured under vacuum (−850 mbar) and under pressure (5 bar) using the usual curing peripherals. After curing, the sheet is cut into strips. As a preference, the strips have a thickness less than or equal to 1 mm, and more preferably less than or equal to 0.7 mm.

The polymer matrix of each composite layer of the laminate 16 comprises a thermosetting polymer or a thermoplastic polymer, used respectively by itself or as a blend with other polymers. Preferentially, the polymer matrix may be selected from among the thermosetting resins of the polyepoxide, unsaturated polyester, vinyl ester, ester cyanate, bismaleimide, type, polyurethanes, and a blend of such resins, or else from thermoplastic resins such as polyesters (PET, PBT, PEN, PBN), polyamides (nylon, aramid), polyimides, polyethersulfones, polyphenylenesulfones, polyketones (PK, PEEK). Of the aforementioned resins, those that are particularly suitable are thermosetting resins having a glass transition temperature greater than or equal to 160° C., and thermoplastic resins having a melting point greater than or equal to 180° C. Note that reinforcing fillers (silica, carbon black) or thermoplastic fillers (Orgasol by Arkema) or elastomeric fillers (Kane Ace by Kaneka) may be added to the above resins. In this instance, the polymer matrix used is a thermosetting polymer matrix consisting of a polyepoxide resin marketed by the NTPT company under the trade name “ThinPreg 402™”.

Particularly well-suited to the invention are composite layers that have a surface density of around 200 g/m² and a pre-curing thickness of around 0.2 mm.

As a preference, use is made of finer layers having a surface density less than or equal to 80 g/m², more preferably this density ranging from 18 g/m² to 80 g/m², and a pre-curing thickness less than 0.06 mm.

The person skilled in the art will know how to adapt the number of composite layers according to the surface density of these composite layers.

The low-modulus oriented fibres 15 of each inner composite layer 17a are chosen from among polyester fibres, cellulose fibres, aliphatic polyamide fibres, and mixtures of these fibres. The low-modulus oriented fibres 15 of each inner composite layer 17a comprise polyethylene terephthalate fibres, reference 755-220 tex, made by DuraFiberTech, having a modulus of extension equal to 10 GPa. Preferably, the polyethylene terephthalate oriented fibres predominate, that is to say represent more than 50% of the fibres of any one inner composite layer 17a. More preferably still, the oriented fibres 15 of each inner composite layer are made up of polyethylene terephthalate fibres. The polymer matrix/oriented fibres 15 ratio by volume in each inner composite layer 17a ranges from 25/75 to 55/45, and in this case is equal to 50/50.

The high-modulus oriented fibres 15′, 15″ of each outer composite layer 17b, 17c are chosen from among glass fibres, carbon fibres, aromatic polyamide or copolyamide fibres, basalt fibres, quartz fibres, and mixtures of these fibres. In this case, the high-modulus oriented fibres 15′, 15″ comprise carbon fibres, reference HS40, made by Mitsubishi, having a modulus of extension equal to 455 GPa. Preferably, the carbon fibres are predominant, meaning that they represent more than 50% of the fibres of any one outer composite layer 17b, 17c. More preferably still, in this case, the oriented fibres of each outer composite layer 17b, 17c of the laminate 16 are made up of carbon fibres. The polymer matrix/oriented fibres ratio by volume in each outer composite layer 17b, 17c ranges from 30/70 to 90/10, and in this case is around 50/50.

In other possible variants, the high-modulus oriented fibres 15′, 15″ comprise glass fibres. Preferably, the glass fibres are predominant, meaning that they represent more than 50% of the fibres of any one outer composite layer 17b, 17c. More preferably still, the oriented fibres of each outer composite layer 17b, 17c of the laminate 16 are made up of glass fibres. In these variants, the polymer matrix/fibre ratio by volume in each composite layer of laminate ranges from 30/70 to 70/30, and is preferably around 45/55.

In yet another variant, the high-modulus oriented fibres 15′, 15″ comprise aramid fibres, basalt fibres or quartz fibres.

FIG. 3B illustrates another embodiment of a crown reinforcing zone 10 of a tyre according to the invention. According to this embodiment, the crown reinforcing zone 10 is made up of four plies 12 of strips 14 embedded in a matrix 13 of rubber compound. In this embodiment, the mean overlap between the strips of each ply of strips overlapping the strips of the ply of strips radially on the inside thereof is greater than or equal to 20%, preferably greater than or equal to 40%, and less than or equal to 80%, preferably less than or equal to 60%.

Comparative Tests

The tyre 1 according to the invention, described above (also denoted by the reference P1 in the following text), a tyre PT1 according to the prior art WO2017/013575 (FIG. 8) comprising strips BT1, and three control tyres PT2, PT3 and PT4 whose characteristics are described below, comprising strips BT2, BT3, BT4 respectively, were compared.

The strips of the tyre PT1 according to the prior art WO2017/013575 are made with a PET (polyethylene terephthalate) matrix incorporating filamentary reinforcing elements (aramid, plied yarns made up of 2 strands of 167 Tex twisted together with a twist of 315 tpm) at 0°. They have a thickness of 0.5 mm.

The tyre PT2 is identical to the tyre P1 except for the fact that the oriented fibres 15 of the inner composite layers 17a are fibres with a high modulus of more than 55 GPa, in this case type H high-modulus glass fibres marketed by the Owens Corning company, having a modulus of extension equal to 80 GPa.

The tyre PT3 is identical to the tyre P1 except in that the crown reinforcing zone of the tyre PT3 comprises a hooping ply comprising a filamentary hoop reinforcing element (aramid, plied yarn consisting of two 167 tex strands twisted together with a twist of 315 tpm) at 0°, and in that each laminate 16 is made up of 6 composite layers comprising type H high-modulus glass fibres marketed by the Owens Corning company, parallel to each other and forming an angle of −45° or +45° with the circumferential direction, so that the composite layers are such that they are arranged two by two, radially on either side of the mid-plane at an equal distance therefrom, so that the angle formed with the circumferential direction by the fibres of the first of the composite layers of the pair of layers concerned, which is located on one side of the mid-plane, is the opposite of the angle formed with the circumferential direction by the fibres of the second of the composite layers of the pair of layers concerned, which is located on the other side of the mid-plane. Each laminate 16 comprises no low-modulus fibres and no fibres oriented at an angle of less than 10° in absolute terms.

The tyre PT4 is identical to the tyre P1 except for the fact that the oriented fibres 15 of the inner composite layers 17a are fibres with a high modulus of more than 55 GPa, in this case type H high-modulus glass fibres marketed by the Owens Corning company, and in that the fibres 15′, 15″ of the outer composite layers 17b, 17c are fibres with a low modulus of less than 30 GPa, in this case 220 tex PET fibres, reference 755, made by DuraFiberTech, having a modulus of extension equal to 10 GPa.

Mass of the Tyre

The tyre was weighed using scales.

An index of 100 is attributed arbitrarily to the mass of a control tyre. An index lower than 100 for the tyres compared with the control tyre indicates that the compared tyres have a lower mass than the control tyre, something which is highly favourable for rolling resistance performance.

Cornering Stiffness

In order to measure drift thrust, each tyre was mounted on a wheel of appropriate size and inflated to 2.4 bar. The tyre was driven at a speed of 80 km/h on a suitable automatic machine (machine of the “flat-track” type marketed by MTS). The load, denoted “Z”, was varied for a slip angle of 1 degree, and the cornering rigidity or drift thrust denoted “D” (corrected for the thrust at zero drift) was measured in the known way by recording, by means of sensors, the transverse load on the wheel as a function of this load Z; the drift thrust is the gradient of the D(Z) curve at the origin. An index of 100 is attributed arbitrarily to the control tyre. An index higher than 100 for the tyres compared with the control tyre indicates that the compared tyres have a cornering stiffness that is improved by comparison with the control tyre.

Noise Generated

The noise known as “coast-by” noise represents the acoustic annoyance suffered by a resident when a vehicle passes by at constant speed on ground having an intermediate particle size, such as a motorway: a vehicle is made to pass by at a given speed, with the gearbox in neutral and the engine switched off, over a standardized measurement area (ISO DIS 10 844 standard); microphones record the noise levels in dB(A).

Conformability

Conformability is evaluated by measuring the force required to provide the necessary radial and circumferential deformations for moulding the tyre in its curing mould. The tyre PT1 is denoted ‘=’. The greater the force, the less conformable the tyre is (denoted ‘-’ or ‘ - -’). The smaller the force, the more conformable the tyre is (denoted ‘+’ or ‘++’).

Hooping

To estimate the hooping capacity, the extension stiffnesses of the strips in the circumferential direction are calculated. As this extension stiffness increases, and if it is above 100 (the extension stiffness of the strip BT1), the hooping of the tyre will improve. Conversely, as this extension stiffness decreases, and if it is below 100, the hooping of the tyre will be poorer.

Table 1 below summarizes all the results for a comparison of the mass, the cornering stiffness, the noise generated, and the ease of using the tyre manufacturing method (conformability).

TABLE 1

| | BT1 | BT2 | BT3 | BT4 | 14 |
|---|---|---|---|---|---|
| Hooping | 100 | 165 | 6 | 165 | 115 |
| | PT1 | PT2 | PT3 | PT4 | P1 |
| Mass | 100 | 98 | 96 | 98 | 98 |
| Cornering stiffness | 100 | 103 | 97 | 100 | 102 |
| Noise generated | 100 | 100 | 98 | 100 | 96 |
| Conformability | − | − | + | − | ++ |

It can be seen that the tyre P1 according to the invention exhibits improved performance in terms of extension and shear by comparison with the tyres PT1, these improvements being demonstrated by the results for hooping and cornering stiffness.

Additionally, because of the use of low-modulus reinforcing elements forming an angle of less than or equal to 10° with the circumferential direction, the tyres PT3 and P1 generate little noise by comparison with tyres PT1, PT2 and PT4, in which the reinforcing elements forming an angle of less than or equal to 10° with the circumferential direction have a high modulus. The observed differences of 2 and 4 points in the generated noise performance index are significant.

Finally, because of the use of reinforcing elements in the form of inner composite layers in which the oriented fibres form an angle of less than or equal to 10° with the circumferential direction, the hooping provided by the strips 14 of the tyre P1 is better than that provided by the strips BT1 of the tyre PT1, and greatly superior to that provided by the strips BT3 of the tyre PT3, which requires the use of a supplementary hooping ply.

1.-15. (canceled)

16. A tire comprising a carcass ply connecting two beads via two sidewalls, the carcass ply being surmounted radially toward an outside of the tire by a crown reinforcing zone which is itself surmounted radially toward the outside of the tire by a tread, the crown reinforcing zone comprising a plurality of reinforcing strips arranged in at least one ply of reinforcing strips, the reinforcing strips of each ply being arranged so that they are juxtaposed axially and each forms an angle of less than or equal to 10° with the circumferential direction, and the circumferential direction corresponding to a periphery of the tire and being defined by a direction of running of the tire,
wherein each reinforcing strip is made up of a laminate consisting of n>1 inner composite layer or layers,
wherein if n>1, the inner composite layers are juxtaposed radially with each other, each inner composite layer comprising oriented fibers parallel to each other, the angle of which to the circumferential direction is less than or equal to 10° in absolute terms, the oriented fibers of each inner composite layer having a modulus of extension of less than or equal to 30 GPa and being coated with a polymer matrix, and the inner composite layer or layers being framed radially on either side, respectively, by m≥1 outer composite layers,
wherein if m>1, the outer composite layers are juxtaposed radially with each other on either side of the inner composite layer or layers, each outer composite layer comprising oriented fibers parallel to each other, the angle of which with the circumferential direction is greater than 10° in absolute terms, and the oriented fibers of each outer composite layer having a modulus of extension greater than or equal to 55 GPa and being embedded in a polymer matrix.

17. The tire according to claim 16 further comprising at least two plies of reinforcing strips, a first ply of reinforcing strips radially on an inside and a second ply of reinforcing strips radially on an outside, the reinforcing strips of each first and second ply being arranged so as to be juxtaposed axially and each forms an angle of less than or equal to 10° with the circumferential direction.

18. The tire according to claim 17, wherein a mean overlap between the reinforcing strips of the first and second plies is greater than or equal to 20%.

19. The tire according to claim 17, wherein a mean overlap between the reinforcing strips of the first and second plies is less than or equal to 80%.

20. The tire according to claim 16, wherein each ply of reinforcing strips is embedded in a matrix of rubber compound which, when cross-linked, has a secant extension modulus at 10% elongation greater than or equal to 10 MPa.

21. The tire according to claim 16, wherein the angle formed by the oriented fibers of each inner composite layer with the circumferential direction is, in absolute terms, less than or equal to 5°.

22. The tire according to claim 16, wherein the angle formed by the oriented fibers of each outer composite layer with the circumferential direction ranges, in absolute terms, from 30° to 60°.

23. The tire according to claim 16, wherein n ranges from 1 to 20.

24. The tire according to claim 16, wherein m ranges from 1 to 8.

25. The tire according to claim 16, wherein a sum of the angles formed with the circumferential direction by the oriented fibers of all the outer composite layers arranged radially on any one side of the inner composite layer or layers of each laminate is equal in absolute terms to a sum of the angles formed with the circumferential direction by the oriented fibers of all the outer composite layers arranged radially on the other side of a mid-plane of the laminate.

26. The tire according to claim 16, wherein a sum of the angles formed with the circumferential direction by the oriented fibers of the outer composite layers of each laminate is equal to 0°.

27. The tire according to claim 16, wherein the angle of the oriented fibers of two outer composite layers positioned symmetrically on each side of the inner composite layer or layers is identical.

28. The tire according to claim 16, wherein the angle of the oriented fibers of two outer composite layers positioned symmetrically on each side of the inner composite layer or layers is identical in absolute terms but of opposite sign.

29. The tire according to claim 16, wherein an absolute value of a ratio of each angle formed by the oriented fibers of an outer composite layer of each laminate to the angle formed by the oriented fibers of each other outer composite layer of the laminate ranges from 0.8 to 1.2.

30. The tire according to claim 16, wherein the polymer matrix of each composite layer of laminate comprises a thermosetting polymer or a thermoplastic polymer.
